(19) United States
(12) Patent Application Publication
(10) Pub. No.: US 2012/0236940 A1
(43) Pub. Date: Sep. 20, 2012

(54) Method for Efficient Parallel Processing for Real-Time Video Coding

(75) Inventors: Ran Katzur, Potomac, MD (US); David Bell, Frederick, MD (US)

(73) Assignee: TEXAS INSTRUMENTS INCORPORATED, Dallas, TX (US)

(21) Appl. No.: 13/049,298

(22) Filed: Mar. 16, 2011

(51) Int. Cl. H04N 7/32

(52) U.S. Cl. 375/240.16; 375/E07.123

(57) ABSTRACT

Embodiments of the invention include a parallel method for real-time video encoding in a multicore processor system. A first frame of video data is divided into groups. Each group has one or more rows of a plurality of macroblocks. Motion estimation is performed on a second group following a first group by a first core of said multicore system. While said motion estimation is being performed by said first core, compression-and-reconstruction is performed on said first group by a second core.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Embodiments of the invention are directed, in general, to real-time digital video signal processing, and more particularly to devices and methods for real-time video coding.

There are multiple applications for real-time digital video communication, and multiple international standards for video coding have been and are continuing to be developed. Low bit-rate communications, such as, video telephony and conferencing, led to the H.261 standard with bit rates as multiples of 64 kbps, and the MPEG-1 standard provides picture quality comparable to that of VHS videotape. Subsequently, H.263, MPEG-2, and MPEG-4 standards have been promulgated.

Video coding standards include MPEG-1, MPEG-2, and MPEG-4 part 2 standardized by the International Organization for Standardization (“ISO”), H.261 and H.263 standardized by the International Telecommunications Union (“ITU”), and H.264, also known as Advanced Video Coding (“AVC”) or MPEG-4 part 10 standardized jointly by both ISO and ITU. The video compression standards define decoding techniques and at least a portion of the corresponding encoding techniques used to compress and decompress video. Video compression techniques include variable length coding, motion compensation, quantization, and frequency domain transformation.

H.264/AVC and VC-1 are two recent video coding standards that make use of several advanced video coding tools to provide better compression performance than existing video coding standards. These and other codecs use advanced tools and algorithms to achieve high video compression while maintaining a good perceptual video quality.

With advances in display technology, high definition (HD) TV is becoming ubiquitous in the market place. Most new displays today support 1080i60 or 1080p60 resolutions.

The advanced tools and algorithms to process video HD resolution require high computational load. Special hardware is often used to encode or decode video data. But specialized hardware has some major drawbacks. Specialized hardware is not flexible enough to support multiple use-cases. Specialized hardware is limited to video processing and usually can not process other types of media, and upgrading to a new standard is not always feasible. General-purpose programmable processors (GPU) are more flexible and may perform video processing with the same hardware that it processes other media, such as speech and audio.

Typical speed of state-of-the-art processor may reach 1.2 GHz for processors with a rich set of instructions—digital signal processor (DSP) or general purpose programmable processors (GPU)—or even higher for processors with reduce set of instructions. However, a single-core general-purpose fully programmable processor does not have enough computational power to process real-time high resolution high quality video codec. Multicore processors have been introduced and have enough computational power to encode or decode real-time high resolution high quality video data.

With an increasing number of mobile handsets supporting video, the demand for network support of content streaming and real-time communication has increased significantly. Deployed 3G media gateways can be upgraded to support lower resolutions and frame rate, but such an upgrade does not meet the requirements for video to become a mainstream application due to limited processing capability. In order to support scalable video applications up to HD, a significant increase of video processing capability is needed. Multicore DSPs provide an increase in video processing capability that meets such demand, while satisfying scalability and power efficiency of operators.

A major problem in using multicores processors for video codecs is that video codec algorithms have inherent dependencies on previous frames and on the result of the processing of previous pixels, so that parallel processing of multi-frames or parallel processing of different parts of the same video frame is not straight forward. This fact makes implementations of video codec on multicores processor challenging.

Some video coding standards arrange images and sub-images in a hierarchical fashion. A group of pictures (“GOP”) constitutes a set of consecutive pictures. Decoding may begin at the start of any GOP. A GOP can include any number of pictures, and GOPs need not include the same number of pictures.

Each picture encoded can be subdivided into macroblocks representing the color and luminance characteristics of a specified number of pixels. In MPEG2, H.263 and H.264 coding for example, a macroblock includes information related to a 16×16 block of pixels.

A picture can be either field-structured or frame structured. A frame-structured picture contains information to reconstruct an entire frame, i.e., two fields, of data. A field-structured picture contains information to reconstruct one field. If the width of each luminance frame (in picture elements or pixels) is denoted as C and the height as R (C is for columns, R is for rows), a frame-structured picture contains information for C×R pixels and a field-structured picture contains information for C×R/2 pixels.

A GOP contains multiple types of frames or slices. Intra coded frames (“I-frame”) compressed independently of any other frame. Predictively coded frames (“P-frame”) are reconstructed from the compressed data in that picture and recently reconstructed fields from previously displayed I-frame or P-Frame. Bi-predictively coded frames (“B-frame”) are reconstructed from the compressed data in that picture plus reconstructed fields from previously displayed I- or P-frames and reconstructed fields from I-frames or P-frames that will be displayed in the future. Because reconstructed I-frames or P-frames can be used to reconstruct other pictures, they are sometimes called reference pictures.

Note that although there are no fixed upper bound on the distance between I pictures, it is expected that they will be interspersed frequently throughout a sequence to facilitate random access and other special modes of operation.

Thus, there is a need to significantly increase the video processing capabilities of high density media gateways for high-definition video encoding and video decoding.

### BRIEF DESCRIPTION OF THE DRAWINGS

For a more complete understanding of the disclosure and the advantages thereof, reference is now made to the following brief description, taken in connection with the accompanying drawings and detailed description, wherein like reference numerals represent like parts.

FIG. 1 is an exemplary block diagram illustrative of a video transcoder in accordance with various embodiments.

FIG. 2A is a flowchart illustrative of a video encoder.

FIG. 2B is a flowchart illustrative of a video decoder.

FIG. 3 shows a partition of H.264 encoder algorithm into three parts.

FIG. 4 shows a simple H264 encoder pipeline.

FIG. 5 shows a very high bit rate system.

FIG. 6 shows a complex motion estimation method.

FIG. 7 is illustrative of averaging the neighbors.

FIG. 8A shows horizontal slicing.

FIG. 8B shows vertical slicing.

FIG. 9 shows vertical slicing for compression and reconstruction.

FIG. 10 shows multicore processing of decoder.

FIG. 11 is a flowchart illustrative of the processing in accordance with an embodiment of the invention.

FIG. 12 shows multicore processing of decoder with deblocking filter on separate core.

### DETAILED DESCRIPTION

It should be understood at the outset that although an exemplary implementation of one embodiment of the disclosure is illustrated below, the system may be implemented using any number of techniques, whether currently known or in existence. The disclosure should in no way be limited to the exemplary implementations, drawings, and techniques illustrated below, including the exemplary design and implementation illustrated and described herein, but may be modified within the scope of the appended claims along with their full scope of equivalents.

Preferred embodiment video encoding and decoding methods provide multicore parallel processing by partition video encoder and decoder processing into multiple parts that can be processed independently.

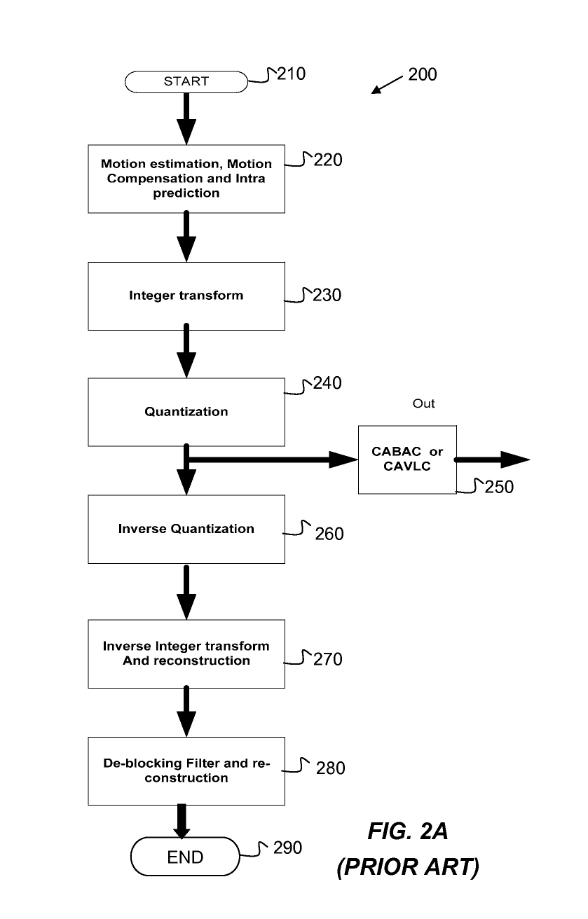

FIG. 2A is a flowchart illustrative of a common video encoder 200 known in the art. Encoder starts 210, motion estimation, motion compensation and intra frame predication is preformed in block 220. The inputs to the motion estimation block 220 are current frame and reference frames. The motion estimation finds the best matching block, according to a certain criteria, from the reference frame to the current block. The motion information is provided to motion compensation function. Motion compensation and intra prediction are coupled to a frame memory to receive the reference frame. A prediction frame is constructed with the use of the motion vectors for each inter block together with the reference frame. The values of the prediction frame for inter blocks are calculated from the previously decoded frame. This type of prediction is referred as motion compensated prediction. It is also possible to use more than one reference frame. In such a case, different blocks of the current frame may use different reference frames. For pixels which belong to intra blocks, prediction blocks are either calculated from the neighboring regions within the same frame or are simply set to zero.

In integer transform block 230, each block in the prediction error is represented as weighted sum of a transform basis functions. The weights corresponding to the basis functions are called prediction error coefficients. Coefficients may be calculated by performing so called forward transform. Motion vectors and quantized coefficients are usually encoded using an entropy coder 250, for example, Variable Length Codes (VLC). The purpose of entropy coding is to reduce the number of bits needed for their representation. Certain values of motion vectors and quantized coefficients are more likely than other values. Entropy encoded motion vectors and quantized coefficients as well as other additional information needed to represent each coded frame of the image sequence are output constitutes a bitstream using context-adaptive binary arithmetic coding (CABAC) or context-adaptive variable-length coding (CAVLC) both forms of entropy coding used in H.264/MPEG-4 AVC video encoding. The quantization block 240 is coupled to an inverse quantization block 260 and in turn an inverse transform and reconstruction block 270. Blocks 260 and 270 provide decoded prediction error which is added to the motion compensation/intra predicted frame. These values may be further normalized and filtered. The resulting frame is called the reconstructed frame and may be stored in frame memory to be used as reference for the prediction of future frames. A de-blocking filter 280 may be applied to blocks for reconstruction to improve visual quality and prediction performance by smoothing the sharp edges which can form between macroblocks. Process ends 290.

FIG. 2B is a flowchart illustrative of common video decoder 201 known in the art. Entropy decoder 211 implementing decoding. As in FIG. 2A, there is an inverse quantization block 221 and in turn an inverse transform and reconstruction block 231. Blocks 221 and 231 provide decoded prediction error which is added to the motion compensation/intra predicted frame. A de-blocking filter 241 may be applied to blocks for reconstruction to improve visual quality and prediction performance by smoothing the sharp edges which can form between macroblocks. Process ends 251.

System which implement embodiments of the invention include, but are not limited to encoders, decoders, transcoders, media gateway system, video content generation, video distribution, setup boxes, and the like. Methods of embodiments of the invention work with any of several types of hardware based on multicore architecture, such as multiple digital signal processors (DSPs), general purpose programmable processors (GPU) and the like. A stored program in an onboard or external (flash EEP) ROM or FRAM may implement the signal processing methods. Ethernet port may provide formats for transmission over networks. High bit-rate digital interface may provide methods for digital video data input and output. A video encoding or decoding method in accordance with an embodiment of the invention may be a real-time system that provides enough resources for high definition encoding and decoding using multicores processor.

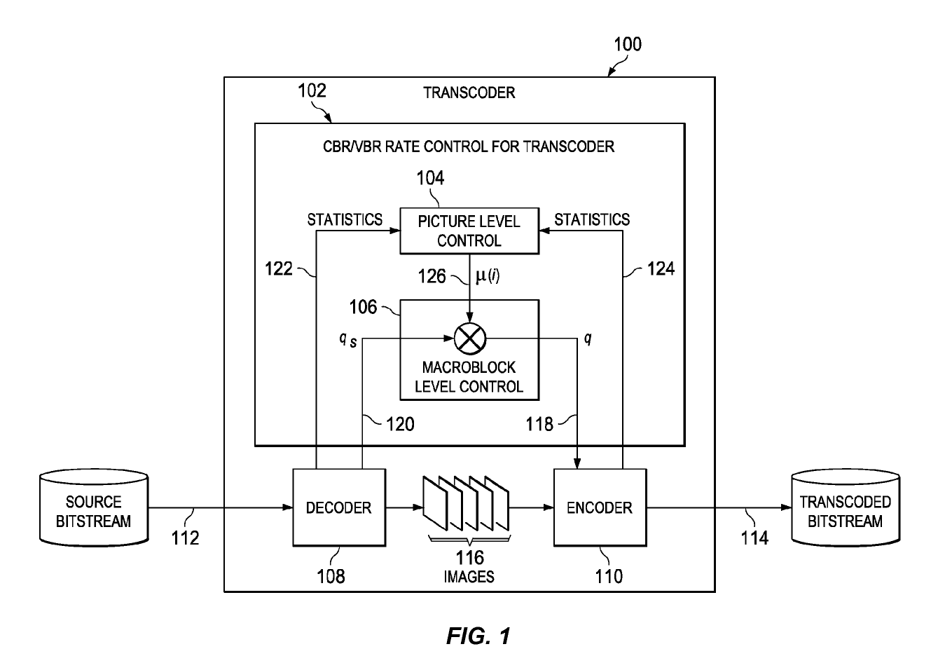

FIG. 1 shows an exemplary transcoder 100 in accordance with various embodiments. The video bitstream 112 provided to the transcoder 100 may be derived from any number of sources, for example, video data broadcast over the air by terrestrial or satellite transmitter, video data transmitted through a cable television system or over the internet, or video data read from a storage medium, such as a digital video disk (“DVD”), a Blu-Ray Disk®, a digital video recorder, etc.

The video data contained in the video bitstream 112 may be encoded in one of a variety of formats, for example, MPEG-2 or H.264. Furthermore, the encoded data can meant for display at one of several resolutions (e.g., 1280×720 (“720 p”) or 1920×1080 (“1080i” or “1080p”), and/or provided at a bitrate that may be inappropriate for some display devices.

The transcoder 100 produces a transcoded video bitstream 114 containing image data derived from the video bitstream 112 encoded in a different format and/or provided at a different bitrate and/or prepared for display at a different video resolution. Thus, the transcoder 100 allows for display of video on a device that is incompatible with the video bitstream 112.

The transcoder 100 includes a decoder 108, an encoder 110, and rate controller 102. The decoder 108 decompresses (i.e., decodes) the video bitstream 112 to provide a set of video images 116. The encoder 110 analyzes and codes the images 116 in accordance with a selected coding standard (e.g., H.264), and/or bitrate and/or display resolution (e.g., 640×480 “VGA”) to construct the transcoded bitstream 114. In some embodiments, the encoder 110 may include motion prediction, frequency domain transformation (e.g., discrete cosine transformation), quantization, and entropy coding (e.g., Huffman coding, context-adaptive binary arithmetic coding (CABAC) or context-adaptive variable-length coding (CAVLC)).

The rate controller 102 compute quantization parameters 118 that are provided in the encoder 110 to facilitate compression of the data contained in the transcoded bitstream 114. The rate controller 102 comprises a picture (i.e. frame) level controller 104, and a macroblock level controller 106. The picture level controller 104 processes statistical information 122 derived from the decoder 108 and statistical information 124 derived from the encoder 110 to produce a quantizer scaling value 126. Examples of the statistical information employed include an estimate of the average coded bit count of the video bitstream 112, the target average bitrate, pixels in a video bitstream 112 picture, and bits and pixels in a transcoded bitstream 114 picture. A scaling value 126 is generated for each picture and provided to the macroblock level controller 106.

The macroblock level controller 106 determines a quantization parameter 118 for each macroblock of the transcoded bitstream 114. Embodiments of the macroblock level controller take advantage of quantization parameters provided in the video bitstream 112 to improve the quality of the transcoded video. More specifically, quantization parameters 120 associated with one or more macroblocks in the video bitstream 112 that contribute to a transcoded macroblock are processed to generate the quantization parameter 118 for the corresponding transcoded macroblock. The macroblock level controller 106 multiplies the video bitstream 112 macroblock quantization parameter 120 corresponding to the macroblock being transcoded with the scaling value 126 to produce the quantization parameter 118.

The transcoder 100 may be implemented as multicore processor, for example, a digital signal processor, microprocessor, microcontroller, etc., executing a set of software modules stored in a processor readable medium (e.g., semiconductor memory) that configure the processor to perform the functions described herein, or as dedicated circuitry configured to provide the disclosed functions, or as a combination of a processor, software, and dedicated circuitry.

First, consider encoder parallel processing. Two common methods for partitioning an encoder between multiple cores are group of picture GOP based processing and slice-based processing. Both of these methods are known in the art. Embodiments of the invention use a functional-based partition. The method described may be used for frame processing and for slice processing. In the description of the embodiments, the terms frame and frames are used to include both cases (e.g. frame or frames processing and slice or slices processing).

A simple encoder solution is dividing the frame or slice into sections and using multiple cores, each one process a different part of the complete frame. This cannot be easily done because of the inter-dependencies between macroblock results. Intra-prediction of a macroblock, one of the first steps in the H.264 encoder algorithm, cannot be calculated unless the macroblocks on top of it and to the left were already reconstructed, the last stage of the encoder before the entropy encoder.

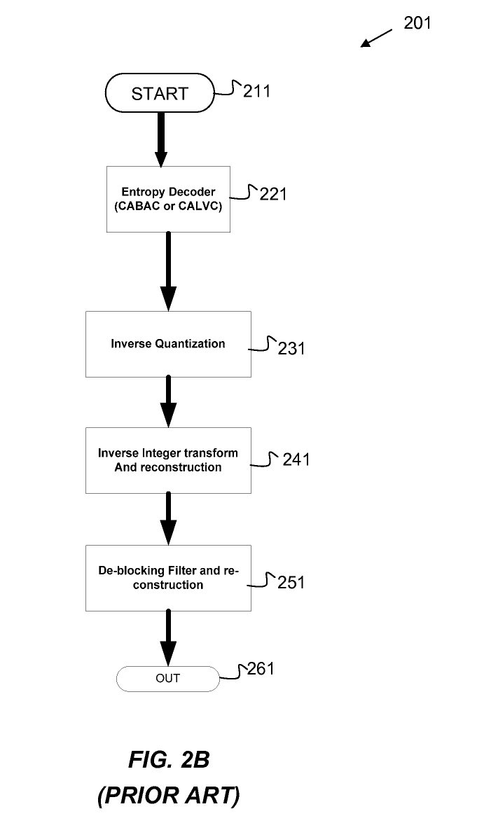

FIG. 3 shows a partition of H.264 encoder algorithm 300 into three parts; motion estimation 310, compression-and-reconstruction 320, and entropy encoding 330. The entropy encoder 330 may be pipelined with the result of the compression-and-reconstruction in the following way. While one (or more) core is working on the compression-and-reconstruction of frame or slice N, another core does the entropy encoding of a previous frame or slice N−1. Note that compression-and-reconstruction 320 may include intra-prediction, integer transform, quantization and rate control, inverse quantization, inverse transform, reconstruction, and loop filtering. Motion compensation may be part of the motion estimation 310 or part of the compression-and-reconstruction 320. If motion compensation is part of the motion estimation processing, it may unnecessarily calculate the motion compensation of macroblocks with better intra-prediction.

The motion estimation 310 may be staggered with compression and reconstruction 320 without losing the ability to execute any of the H.264 tools in the following way. Divide a frame into sections or groups; each has one or more rows of macroblocks. When the motion estimation core is done with the first group, the compression-and-reconstruction core starts processing the first group while the ME (motion estimation) core processes the second group.

### Case 1—Simple Multicore Pipeline

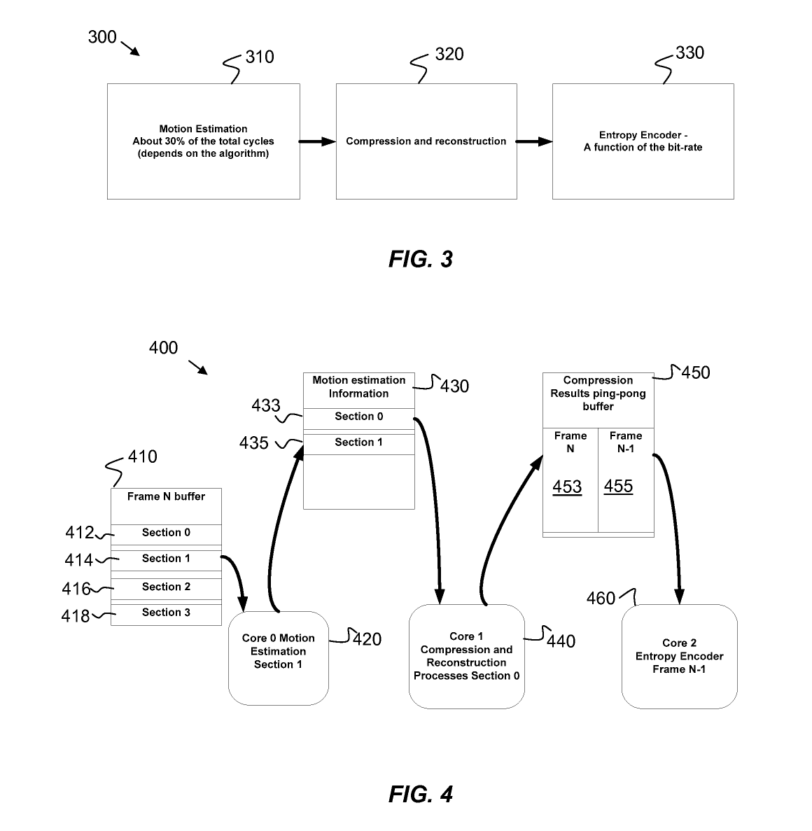

FIG. 4 is illustrative of a simple pipeline that involves three cores that perform H.264 encoding in parallel. Frame N having 4 sections 412, 414, 416, and 418 is kept in buffer 410. Motion estimation information 430 is also kept in a buffer. Core 0 420 performs motion estimation on macroblocks in section 1 of the N'th frame, while core 1 440 performs compression-and-reconstruction on macroblock from the previous section of the same frame and puts the compressed data in a ping-pong buffer 450 to be entropy encoded (frame N 453 and frame N−1 455 in the example). At the same time, Core 2 460 does entropy encoding on the compressed data of frame N−1 455.

Note that when core 0 420 processes the first section of Frame N+1, core 1 440 is still busy processing the last section of frame N. This may limit the maximum motion that is supported by the motion estimation algorithm. The trade-off in determining the size of the section is complexity versus maximum supported motion estimation. As the size of sections increases, so does the processing delay of the motion estimation and the compression. Systems which require short delay may schedule the entropy encoding on section boundary, that is, when core 0 420 performs motion estimation on section N, core 1 440 performs compression and reconstruction on section N−1, and core 2 460 performs entropy encoding on section N−2. Such scheme decreases processing delay but reduce processing efficiency.

### Case 2—Very High Bit-Rate

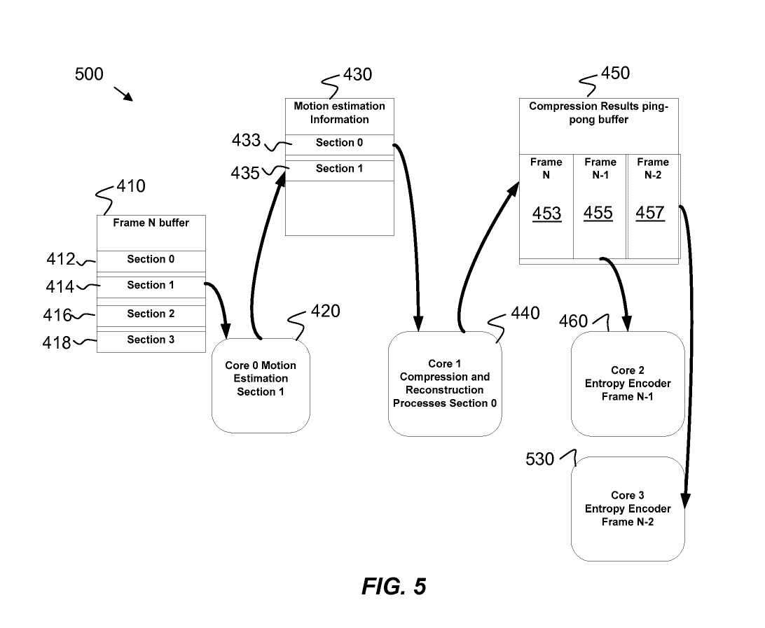

Content generation and storage use-case may employ H.264 encoding which is configured for very high bit rate. In that case, the entropy encoder consumes much more processing cycles than any other part of the encoder. Adding two (or more) cores to perform the entropy encoder enables real-time processing with delay increase. FIG. 5 is illustrative of a possible solution. Core 0 and core 1 perform motion estimation and compression and reconstruction as in case 1. Each of the two cores, core 2 and core 3, performs entropy encoding on different frame. Core 2 on frame N−1, and core 3 on frame N−2 530. Each core consumes double the real-time performances, but because of the parallel execution, the throughput is real-time.

Case 3—Complex Motion estimation

Good motion estimation algorithms may achieve high quality H.264 encoding while keeping the bit rate to a minimum. The more complex the technique used, the better the estimation can be, and the more resources are needed for motion estimation. In this case, a modification of case 1 for real-time encoder system with complex motion estimation algorithm is shown.

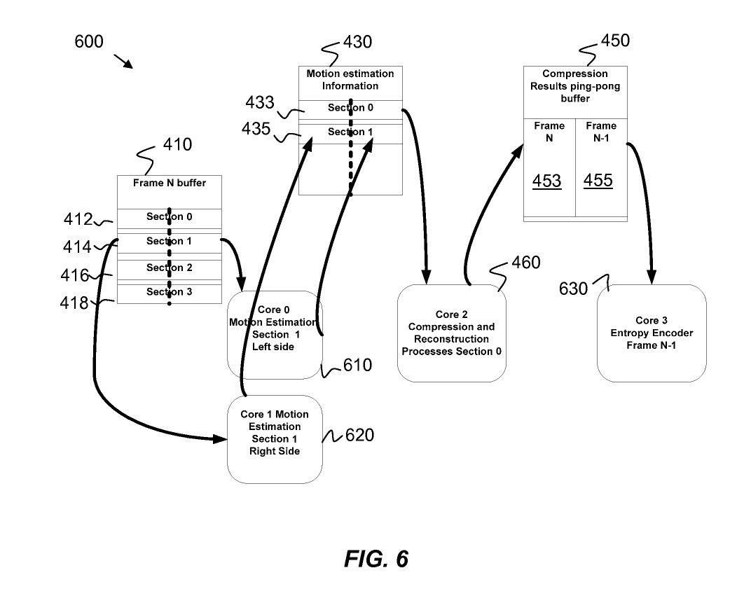

FIG. 6 shows two cores working on the same section. Core 0 processes the left side 610 and core 1 processes the right side 620. In the following, the possible quality degradation of simultaneously processing of motion estimation by more than one core is described.

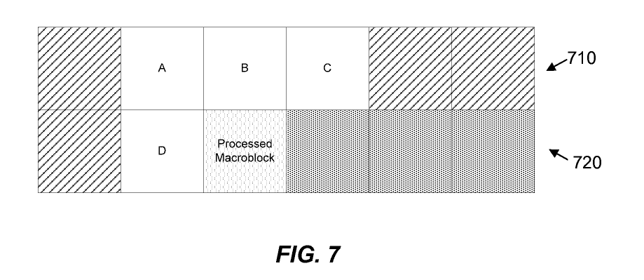

The dependency of motion estimation of one macroblock on the results of other macroblocks depends on the algorithm. A common practice is to have multiple search zones. The first search zone is centered at the same location as the processed macroblock. Some algorithms use global motion to center other search zones. A common practice is to average the motion vectors of the top three macroblocks and the macroblock to the left, macroblocks A, B, C and D as depicted in FIG. 7.

Divide the section between two cores horizontally, 710 and 720, each core processes different row of macroblocks, takes away from the first row of macroblocks in each section the motion vector values of macroblocks A, B, and C, because these values are in the upper section 710 and were not processed yet. Vertical division (also know as slicing) where the two cores work on the same row of macroblock, one starts from the most left macroblock and the second starts processing the middle macroblock takes away from the first column of the second section only the motion vector value of macroblock D.

The number of macroblocks that loses the D value equals to the number of macroblock rows in each section, much smaller than the number of macroblocks in a row, as is the case in horizontal division. Algorithms that define larger search zone for these macroblocks to compensate for the missing motion vector value add negligible processing load. The differences between horizontal and vertical slicing will be explained in detail in the next paragraph.

### Case 4—Large Resolution Case

This case is where the compression-and-reconstruction 320 part of the processing may need more than one core to perform real-time processing. Intra-prediction and loop-filter operations depend on the results of previous macroblocks. When a frame is divided into slices and each slice is processed by a different core, intra-prediction and loop-filtering can not be done on some of the boundary macroblocks. H.264 supports disabling of the loop-filter for some macroblocks, and sub-optimal intra-prediction. However, the compression quality may suffer.

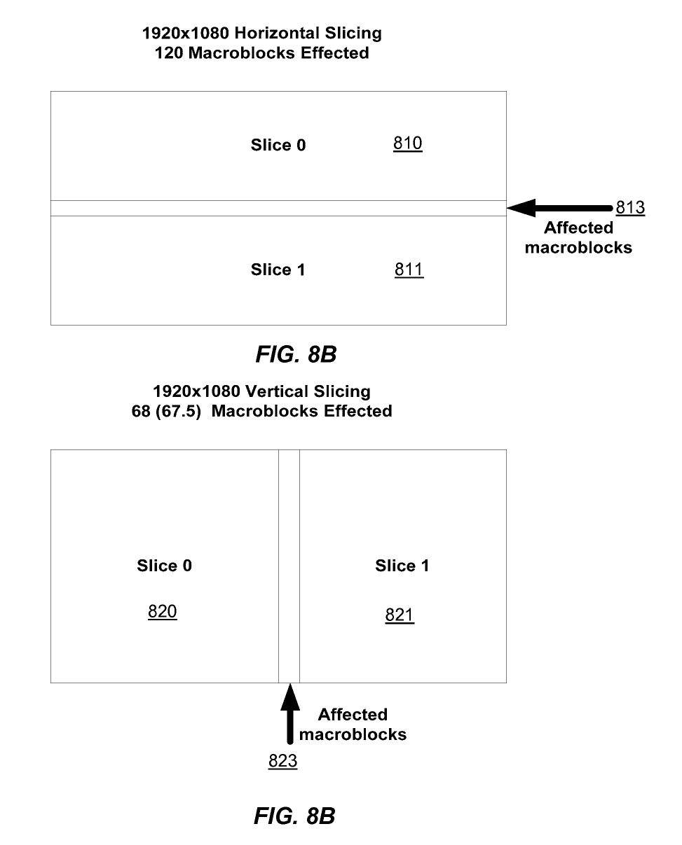

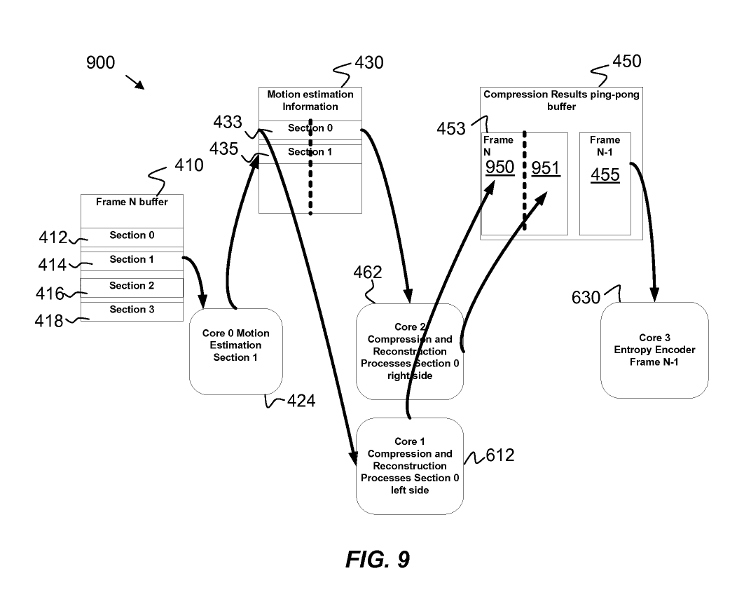

To minimize the effect of multi-slice processing on the frame quality, a vertical division of a frame to slices is suggested. FIG. 8A shows horizontal and two slices 810 and 811. Dependency is lost in the boundaries around the divisions. The macroblocks 813 in the area of the division lose information. FIG. 8b shows vertical slicing with affected macroblocks 823. There is an advantage with vertical slicing. Not only the number of affected macroblocks 823 is smaller for vertical slicing or division as there are more macroblocks in a row than rows of macroblocks, but as it is clear from FIG. 7, there is less loss of information for the affected macroblocks 823. FIG. 9 describes vertical slicing of the compression and reconstruction processing. Frame N 453 is divided into two slices 950 and 951.

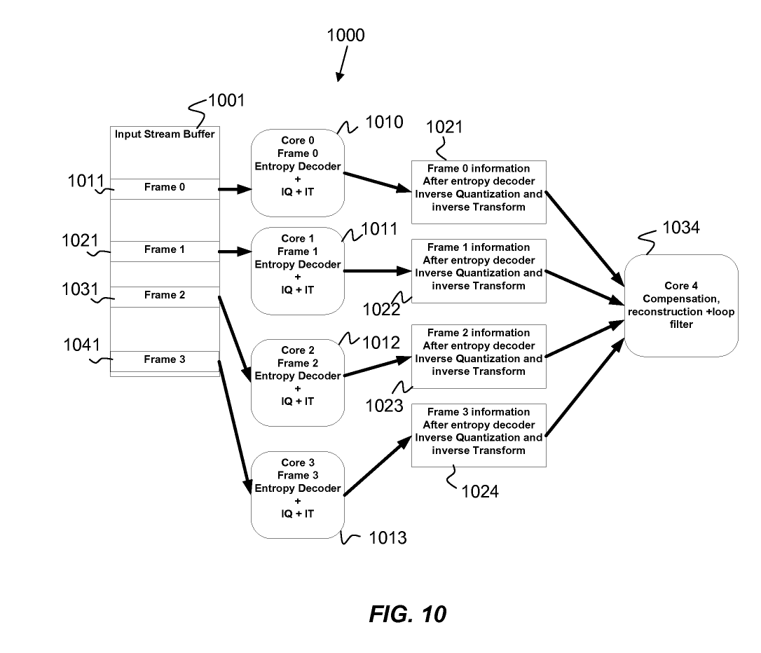

Following is a description of a method for decoder processing. FIG. 10 is illustrative of a real-time multicore decoder of high quality high bit-rate system 1000. Frame (or slice) decoder processing may be divided into two parts, processing that is independent from any other frame, such as entropy decoder 1010-1013 and processing that depends on previously reconstructed frame, such as motion compensation. Multiple frames processing of the independent part may be done in parallel by multiple cores, while the dependent processing of a frame can not start before the completion of the processing of the previous frame.

Decoder processing depends on the content less than encoder processing. The entropy decoder is a function of the bit-rate (some dependency on the type of the bits that depends on the content of the original video). The inverse quantization and inverse transform 1021-1024 depends only on the number of macroblocks and the transform mode (e.g. 4×4, 8×8). All other processing steps have a weak dependency on the tools that were used by the encoder, some may be content dependent, but mostly the processing load may be a function of the number of macroblocks--the resolution.

Typical bit-rate may approach 50 Mbps (for example H.264 level 4.1 and 4.2) or more (H264 Level 5 supports up to 135 Mbps). For these bit-rates, entropy decoder consumes most of the processing power.

When the input data is streamed and buffered into the processor memory 1001, there must be a way to detect the start of the next frame or slice. Different video streams have different markers to identify the start of a new frame (or slice) and the end of the previous one. For example, H264 marker is 0x00000001.

The case of FIG. 10 uses four cores to perform entropy decoder and inverse quantization (IQ) and inverse transform (IT), each of the first four cores processes a different frame. Shown are four frames 1011, 1021, 1031, and 1041.

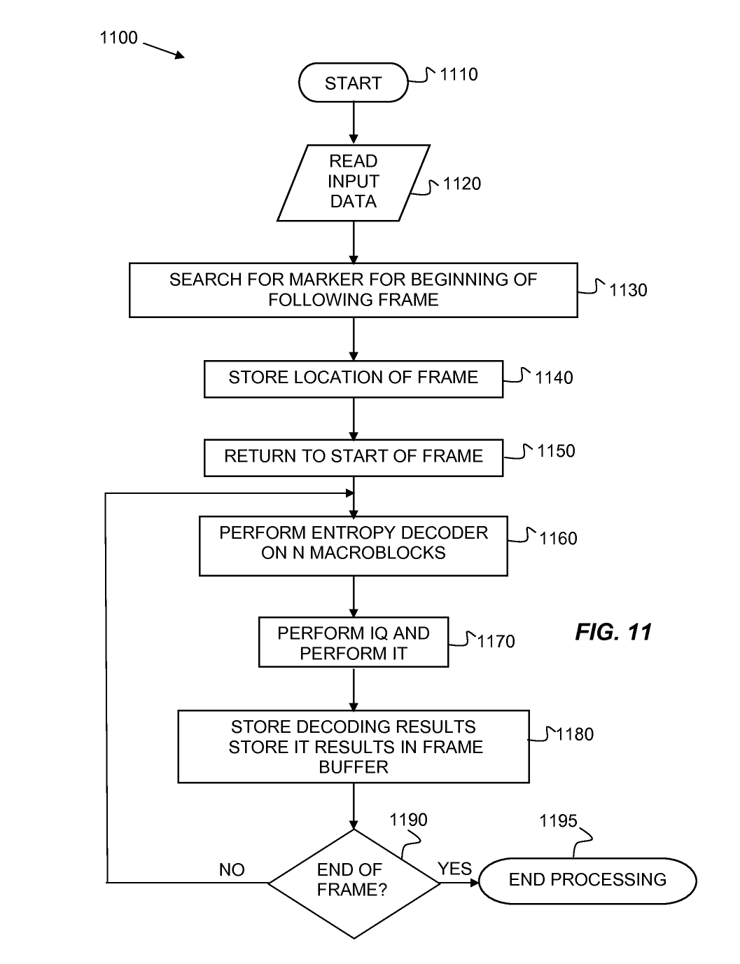

The algorithm of the independent processing core starts when the code is called with a pointer to the location of the first byte of the next frame. FIG. 11 is a flowchart illustrative of decoding 1100 in accordance with an embodiment of the invention. The method starts 1110 by reading the input data 1120. A search is started for a marker of the beginning of the following frame 1130. The location of the following frame is stored in a global area memory 1140. The global area is to be read and the frame will be used by the next core. At 1150, the method returns to the start of the frame 1150, starting the following loop:
Perform entropy decoder on N macroblocks 1160. The number N is chosen to optimized performance;
Perform inverse quantization (IQ) and inverse transform (IT) on the block values that were decoded in the previous step 1170;
Store the decoding results and the results of the inverse transform in a frame buffer 1180; and
When it reaches the end of the frame it ends processing.
   To start a new frame processing, read the location of the next frame from the global memory and the loop is repeated.

To achieve a real-time system, the average time it takes each one of the four cores that do the entropy decoding and IQ and IT should be less than four times frame time, that is, 67 milliseconds for 60 frames a second case, or 134 milliseconds for 30 frames per second case.

The fifth core processes all frames sequentially, starting from frame 0 to frame 1 and so on. To achieve real-time system, the average time it takes for this core to finish reconstruction and loop filter for one frame should be less than frame time, 16.7 milliseconds for 60 frames per second case, or 33.4 milliseconds for 30 frames per second case.

The computational load of the reconstruction depends almost only on the resolution. A single core that runs at 1 GHz or faster has enough processing power to do real-time reconstruction of 1080p60 resolution.

Note that the number of cores that are dedicated for entropy decoder (and the IQ and IT) depends on the maximum bit rate that is defined for the system and can be from 1 to as many as needed to achieve real-time processing.

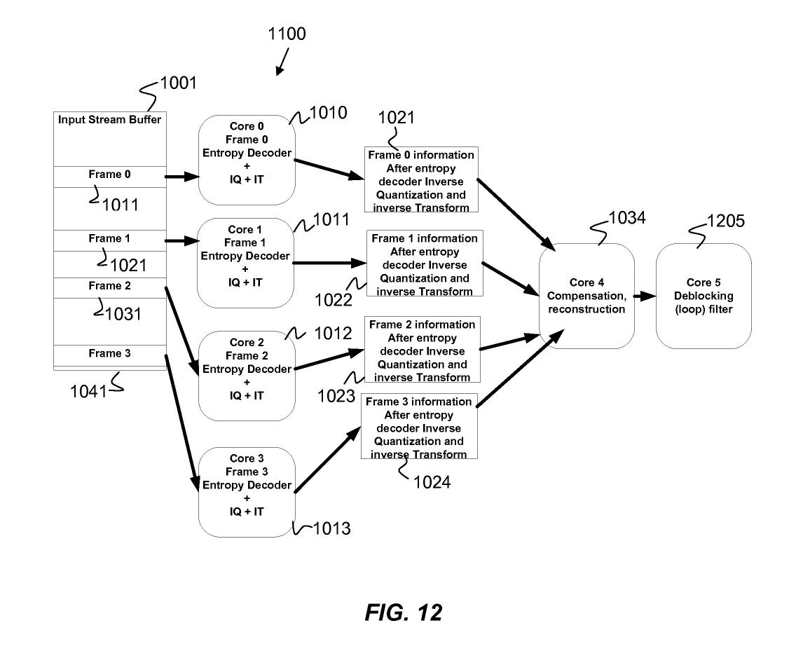

Further partition of the decoder block compensation and reconstruction into two cores can be done as follows. The result of the de-blocking filter is not used during the processing of the current slice or frame. Rather it is used in the motion estimation calculations of the next frame. Thus the de-blocking filter part of the compensation and reconstruction block can be executed in a separate core in a pipeline fashion, and thus reducing the computation load of the core that does the compensation and reconstruction. FIG. 12 shows a real-time multicore decoder of high quality high bit-rate system that is divided into three parts instead of two. The de-blocking part of the processing is done on a different core 1205. Processing de-blocking filter of row N in a frame can start as soon as the compensation and reconstruction part of row N is done.

While several embodiments have been provided in the disclosure, it should be understood that the disclosed systems and methods may be embodied in many other specific forms without departing from the spirit or scope of the disclosure. The examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A parallel method for real-time video encoding in a multicore processor system, said method comprising:
Dividing a first frame of video data into groups; each group comprising one or more rows of a plurality of macroblocks;
Performing motion estimation on a second group following a first group by a first core of said multicore system; and
Performing compression-and-reconstruction on said first group by a second core while said motion estimation is being performed by said first core.

2. The method of claim 1, further comprising:
Storing frame N in a first buffer;
Storing motion estimation information in a second buffer; and
Storing compressed data from in a third buffer of a frame previous to said frame.

3. The method of claim 2 wherein the third buffer is a ping-pong buffer.

4. The method of claim 2, further comprising:
Performing entropy encoding on compressed of said previous frame by a third core as said second core is performing compression-and-reconstruction on said first frame.

5. The method of claim 4, further comprising:
Performing entropy encoding by a fourth cord to a different frame from said previous frame.

6. A multicore processing system supporting real-time video coding, said system comprising:
Multiple processing cores to perform different functions in parallel;
a first buffer for storing a plurality of sections of a frame, each section comprising one or more rows of a plurality of macroblocks;
a second buffer for motion estimation information;
a first core performs motion estimation on macroblocks in a second section following a first section of a frame N following a frame N−1;
a second core performs compression-and-reconstruction on macroblocks from said first section of said frame N and stores a compressed data in a third buffer to be entropy encoded; and
a third core for entropy encoding said compressed data of said frame N−1.

7. The system of claim 6, where said third core works concurrently with said second core.

8. The system of claim 6, further comprising a fourth core, for applying an entropy coding function, wherein said third core and said fourth core works concurrently with said second core.

9. The system of claim 8, wherein said third core and said fourth core each applying entropy coding function to a different frame.

10. A video transcoder, comprising:
multiple processing cores to perform different functions, comprising:
a first core performs for motion estimation;
a second core for compression-and-reconstruction;
a third core applying an entropy coding function; and
a global memory accessible by said cores, said global memory for storing a location of the beginning location of a frame.

11. The transcoder of claim 10, where said third core works concurrently with said second core.

12. The transcoder of claim 10, further comprising a fourth core, for applying an entropy coding function, wherein said third core and said fourth core works concurrently with said second core.

13. The transcoder of claim 12, wherein said third core and said fourth core each apply entropy coding function to a different frame.

14. In a multicore processor system using at least four cores to perform entropy decoding and inverse quantization (IQ) and inverse transform (IT), each of the first four cores processes a different frame, an independent processing core perform a parallel method for real-time video decoding, said method comprising:
receiving an input stream of video data comprised of a plurality of frames;
searching for a beginning location of a first frame;
storing said beginning location in a global memory area accessible by at least two cores of said multicore processor system;
decoding by entropy decoder N macroblocks from said plurality of macroblocks to get a plurality of decoded values, where N is a function for of performance;
perform inverse quantization and inverse transformation on the plurality of decoded values; and
storing the plurality of decoding values and a plurality of results of the inverse transform in a frame buffer.

15. The parallel method of claim 14, further comprising:
Processing all frames sequentially by a fifth core.
